(19) United States
(12) Patent Application Publication
(10) Pub. No.: US 2012/0221673 A1
(43) Pub. Date: Aug. 30, 2012

(54) METHOD FOR PROVIDING VIRTUALIZATION INFORMATION

(75) Inventors: Meong-Hun LEE, Daejeon (KR); Yoon Ju Lee, Daejeon (KR)

(73) Assignee: ELECTRONICS AND TELECOMMUNICATIONS RESEARCH INSTITUTE, Daejeon (KR)

(21) Appl. No.: 13/406,382

(22) Filed: Feb. 27, 2012

(30) Foreign Application Priority Data
Feb. 28, 2011 (KR) 10-2011-0018020

(51) Int. Cl. G06F 15/167

(52) U.S. Cl. 709/213

(57) ABSTRACT

Virtualization information on a first user terminal is generated and is stored in a data storage device through a mobile communication system. When a user with a second user terminal requests virtualization information while the second user terminal provides a first identification number of the first user terminal, the mobile communication system provides virtualization information corresponding to the identification number to the second user terminal. The second user terminal operates the virtualization information corresponding to the first identification number.

### CROSS-REFERENCE TO RELATED APPLICATION

This application claims priority to and the benefit of Korean Patent Application No. 1 0-201 1-001 8020 filed in the Korean Intellectual Property Office on Feb. 28, 2011, the entire contents of which are incorporated herein by reference.

### BACKGROUND OF THE INVENTION

(a) Field of the Invention

The present invention relates to a method for providing information. More particularly, the present invention relates to a method for providing customized user interface (CUI) virtualization information.

(b) Description of the Related Art

Recently, communication services (e.g., a wideband code division multiple access (WCDMA), a global system for mobile communication (GSM), a wireless broadband Internet (WiBro), and others) have been provided and a service in which a user can install, add, or delete various desired applications based on operating systems has also been provided in an intelligent terminal such as a smart phone. This intelligent terminal operates with different operating systems by manufacturer, and thus a user has to use an application supported by the operating system of a terminal.

For a terminal to receive more various services, more software and hardware are needed. However, there are many difficulties for a terminal to include all desired software and hardware. Accordingly, a technique for a user terminal without resources (e.g. hardware, software) to receive a wide range of services in a computing environment that is virtually constructed by combining optimum resources and that is customized for various devices in various locations has been studied. One example of this technique is a service in which users' data may be stored and managed in a network system online, and a user may upload or download the data with a digital device whenever and wherever.

However, a user is only provided with the data that they have uploaded through the service. It is needed for a user terminal to receive a wider variety of data regardless of the operating system.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for a user to use virtualization information customized for the user anytime and anywhere, regardless of types of an operating system (or a platform), a communication service, and a terminal.

One embodiment of the present invention provides a method for providing virtualization information, wherein virtualization information for a first user terminal is stored in a data storage device through a mobile communication system, and the virtualization information includes a first identification number for identifying the first user terminal and information generated by using the first user terminal. The method includes transmitting, by the second user terminal, a message including the first identification number of the first user terminal to the mobile communication system to request virtualization information; and receiving, by the second user terminal, the virtualization information corresponding to the first identification number from the mobile communication system.

The receiving of the virtualization information may include receiving, by the second user terminal, the virtualization information corresponding to the first identification number from the mobile communication system; installing, by the second user terminal, a virtual device for the virtualization information; and executing, by the virtual device, the virtualization information.

Also, the receiving of the virtualization information may include receiving, by the second user terminal, an information and communication service according to execution of virtualization information corresponding to the first identification number from the mobile communication system.

Here, the mobile communication system may execute the virtualization information corresponding to the first identification number through a virtual machine, and provide the information and communication service according to the execution of the virtualization information to the second user terminal.

Another embodiment of the present invention provides a method for providing virtualization information, wherein virtualization information for a first user terminal is stored in a data storage device through a first mobile communication system, and the virtualization information includes a first identification number for identifying the first user terminal and information generated by using the first user terminal. The method includes transmitting, by the second user terminal, a message including the first identification number of the first user terminal to a second mobile communication system to request virtualization information, and receiving, by the second user terminal, the virtualization information corresponding to the first identification number from the second mobile communication system after the virtualization information is sent from the first mobile communication system to the second mobile communication system.

The receiving may include receiving, by the second user terminal, the virtualization information corresponding to the first identification number from the second mobile communication system, installing, by the second user terminal, a virtual device for the virtualization information, and executing, by the virtual device, the virtualization information.

Also, the receiving may include receiving, by the second user terminal, an information and communication service according to execution of virtualization information corresponding to the first identification number from the second mobile communication system.

The second mobile communication system executes the virtualization information corresponding to the first identification number through a virtual machine, and provides the information and communication service according to the execution of the virtualization information to the second user terminal.

The virtual device may include a network layer, and may further include a hardware and kernel layer, a library layer, an operating system layer, and an application and contents layer including a virtual machine, which are shared by the second user terminal.

The virtual device may include a network layer, and may further include a hardware and kernel layer, a library layer, an operating system layer, and an application and contents layer including a virtual machine, which are independent of the second user terminal.

### BRIEF DESCRIPTION OF THE DRAWINGS

FIG. 1 shows a concept of providing virtualization information by using a shallow method according to an exemplary embodiment of the present invention.

FIG. 2 shows a concept of providing virtualization information by using a deep method according to an exemplary embodiment of the present invention.

FIG. 3 shows an operation of each device in conjunction with storing virtualization information according to an exemplary embodiment of the present invention.

FIG. 4 shows a flowchart of a method for providing virtualization information according to the first exemplary embodiment of the present invention.

FIG. 5 shows an operation of each device in conjunction with storing virtualization information according to the first exemplary embodiment of the present invention.

FIG. 6 shows an example for providing customized information to a terminal by the method for providing virtualization information according to the first exemplary embodiment of the present invention.

FIG. 7 shows a flowchart of another method for providing virtualization information according to the first exemplary embodiment of the present invention.

FIG. 8 shows a flowchart of a method for providing virtualization information according to the second exemplary embodiment of the present invention.

FIG. 9 shows an operation of each device in conjunction with storing virtualization information according to the second exemplary embodiment of the present invention.

FIG. 10 shows a flowchart of another method for providing virtualization information according to the second exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. Through the specification, in addition, unless explicitly described to the contrary, the word “comprise” and variations such as “comprises” or “comprising” will be understood to imply the inclusion of stated elements but not the exclusion of any other elements.

In the specification, a terminal may indicate a mobile station (MS), a mobile terminal (MT), a subscriber station (SS), a portable subscriber station (PSS), user equipment (UE), and an access terminal (AT), and it may include entire or partial functions of the mobile station, the mobile terminal, the subscriber station, the portable subscriber station, the user equipment, and the access terminal.

In the specification, a base station (BS) may indicate an access point (AP), a radio access station (RAS), a nodeB (Node-B), a base transceiver station (BTS), and a mobile multihop relay (MMR)-BS, and it may include entire or partial functions of the access point, the radio access station, the nodeB, the base transceiver station, and the mobile multihop relay-BS.

A method for providing virtualization information according to an exemplary embodiment of the present invention will be described with reference to the drawings.

In an exemplary embodiment of the present invention, a user may be provided with information that is optimized for the user, that is, customized virtualization information with a terminal of any operating system through any communication service anytime and anywhere. Here, the virtualization information includes all information that occurs while a user uses a terminal. For example, an individual identification number of a terminal (e.g. a telephone number), information on an application, information stored in a universal subscriber identity module (USIM) card, data stored in a terminal such as a phone book, information on user interface (UI) of a terminal, and financial transaction information are included in the virtualization information. The virtualization information is maintained intact or is encrypted and compressed to be stored and managed in a data storage device.

The virtualization information is driven by an emulator that is a virtualization program installed in a digital device. At least one virtualization information set may be run in a digital device and at least one virtualization information set of a user may be generated, stored, and managed. The virtualization information may also be referred to as a “virtualization image”.

In an exemplary embodiment of the present invention, at least one customized virtualization information set of a user is generated, stored, and managed in a data storage device, and the virtualization information is provided through virtualization of a terminal. Therefore, a user may be provided with virtualization information (or communication, broadcasting) with a user's terminal anytime and anywhere regardless of the terminal type, the operating system, and a network communication service provider.

There are two types of a shallow method and a deep method in a method for virtualizing a terminal to use virtualization information according to an exemplary embodiment of the present invention.

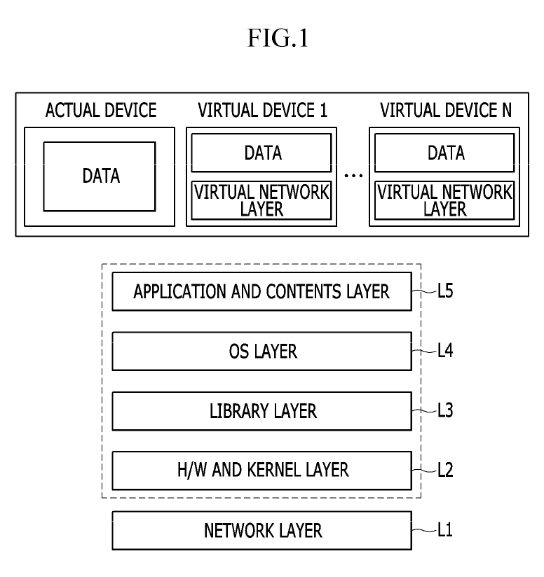

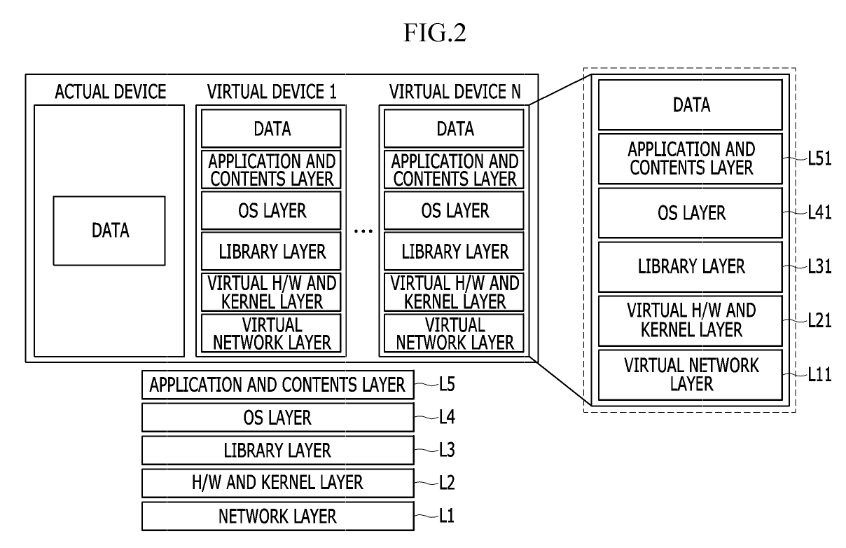

FIG. 1 shows a concept of providing virtualization information by using a shallow method according to an exemplary embodiment of the present invention, and FIG. 2 shows a concept of providing virtualization information by using a deep method according to an exemplary embodiment of the present invention.

Referring to FIG. 1 and FIG. 2, a network layer L1 includes a wired network (e.g., x digital subscriber line (xDSL)) run by a mobile communication service provider, a wireless network (e.g. a wideband code division multiple access (WCDMA), a wireless broadband (WiBro), a long term evolution (LTE), and others), and a broadcasting network. The network layer L1 may indentify a network user with a number assigned to a user terminal, that is, a personal identification number.

A hardware and kernel layer L2 controls an operating system and hardware of a digital device. A library layer L3 is a layer in which functions used in a digital device are combined to a single unit.

An operating system layer L4 is an operating system for operating a digital device and provides all of services supported by a general operating system such as a user interface, a framework, a communication service, a multimedia service, a connection service, and others.

An application and contents layer L5 includes application programs used in a digital device. Here, the application programs include a virtual machine or virtual emulator capable of performing emulation for generating, correcting, and deleting virtualization information. Each layer may be included in one of at least one virtual device, or may be divided by functions and may be included in a virtual device.

A shallow method (may be referred to as a shallow bevel virtual machine method) processes and uses virtualization information while sharing an application, an operating system, a kernel, and others of a device to be used by a user. That is, as shown in FIG. 1, a plurality of virtual devices are implemented in a device to be used by a user, that is, an actual device, through a virtual machine. Each virtual device shares the layers of the actual device, that is, an application and contents layer L5, an operating system layer L4, a library layer L3, and a hardware and kernel layer L2, and further drives the virtual machine in the application and contents layer L5 to use virtualization information of the user. In this case, the personal identification number included in the virtualization information may be only downloaded and used in the virtual device or all data included in the virtualization information may be downloaded and used in the virtual device information.

Meanwhile, a deep method (may be referred as a deep level VM) runs two operating system in a digital device. The deep method virtualizes an original device of a user in a device to be used by the user through a virtual machine. More specifically, the operating system of the user's original device is virtualized in the device to be used by the user apart from the operating system of the device to be used by the user. Accordingly, two operating systems are individually run and virtualization information is processed by the operating system of the user's original device.

As shown in FIG. 2, a plurality of virtual devices are implemented in a device to be used by a user, that is, an actual device, through a virtual machine. Each virtual device is implemented to individually include an application and contents layer L51, an operating system layer L41, a library layer L31, a hardware and kernel layer L21, and a network layer L11. In this case, virtualization information is processed by a virtual machine operated at an individual application layer L41. In the deep method, convenience is provided in that a user can be provided with a wide range of services by using virtualization information in the same environment as the original device, and different operating systems are separately operated. Accordingly, a security function is enhanced. Here, the original device of a user is a device in which virtualization information was generated and has the personal identification number and information included in the virtualization information.

Meanwhile, when a virtual device is implemented by the shallow method or deep method and virtualization information is processed with a personal identification number, a device to be used by a user shares a local network with the virtual device, and thereby there are at least two identification numbers in a device. At this time, a mobile communication network service system provides a network service while matching two identification numbers to the device.

In providing virtualization information according to an exemplary embodiment of the present invention, a virtual device is implemented in a device to be used by a user based on the shallow method or the deep method, and virtualization information of the user is processed through the virtual device.

Next, a method for providing virtualization information according to an exemplary embodiment of the present invention will be described.

First, a process for storing virtualization information of a terminal will be described.

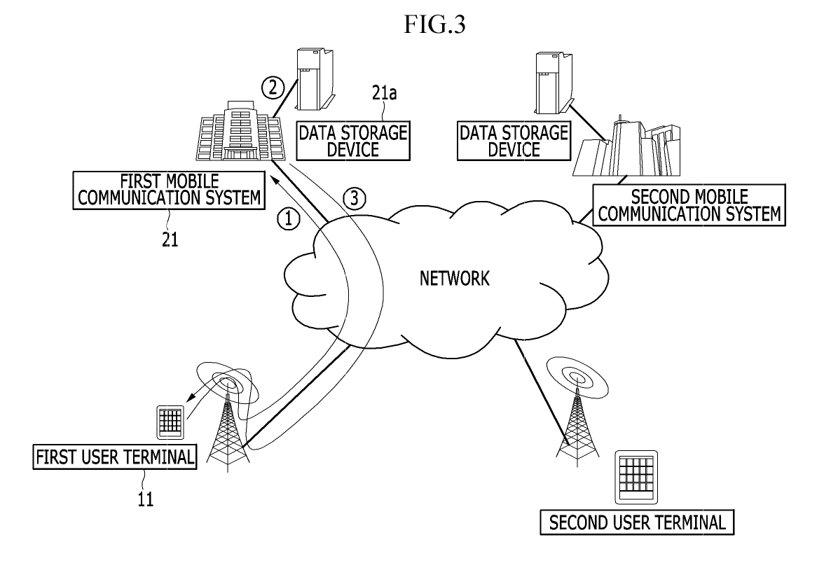

FIG. 3 shows an operation of each device in conjunction with storing virtualization information according to an exemplary embodiment of the present invention.

As shown in FIG. 3, a user subscribed to the service of the first mobile communication network provider generates virtualization information on a desired digital device through a virtual machine. Here, the digital device desired by the user is generated virtualization information and will be referred to as “a user terminal” for better comprehension and ease of description.

If the user selects generating and storing virtualization information in a first user terminal 11, the first user terminal 11 generates, corresponding to a personal identification number such as a phone number, virtualization information including at least one among information related to used applications, information stored in a USIM card only if the USIM card is installed in the first user terminal 11, information stored in the storage of the first user terminal (e.g., information of a telephone book), a user interface, and financial transaction information.

The first user terminal 11 selects information according to the user's select input by an input device like a keypad and generates virtualization information by matching the selected information to the personal identification information through a virtual machine. Accordingly, customized virtualization information is generated.

The first user terminal 11 transmits the generated virtualization information to a system of the first mobile communication network provider, that is, a first mobile communication system 21. The first mobile communication system 21 stores and manages the virtualization information transmitted from the first user terminal 11 in a data storage device 21 a. For indentifying each user, the virtualization information is matched to the personal identification number or another identification number different from the personal identification number, and then is stored and managed. Here, it is assumed that a user is identified with a personal identification number.

The first mobile communication system 21 manages virtualization information that corresponds to each personal identification number by users and is stored. The first mobile communication system 21 generates billing data (e.g. the used time, usage) corresponding to a personal identification number of the user who uses virtualization information or performs security management including providing virtualization information to the user terminal that is authenticated based on the personal identification number.

A user may use virtualization information on the first user terminal 11 anytime and anywhere, and may edit, delete, or update the virtualization information as needed. Also, a user may be provided with the virtualization information and store it to a personal data storage device to use it. Also, it is possible to receive a service for being provided with execution of virtualization information in the form of a stream through the virtualization machine of the first mobile communication system, regardless of the type of device used in receiving the service.

Next, a method for providing virtualization information stored as above to a user will be described.

First, a method for providing virtualization information according to a first exemplary embodiment of the present invention will be described. In the first exemplary embodiment of the present invention, a user is provided with virtualization information that was stored in a mobile communication system by using a different terminal from the terminal used in storing the virtualization information through the mobile communication system.

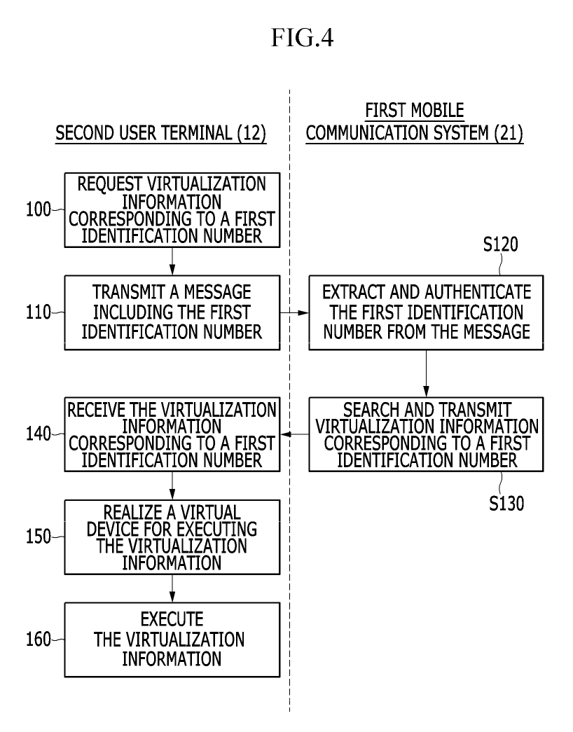

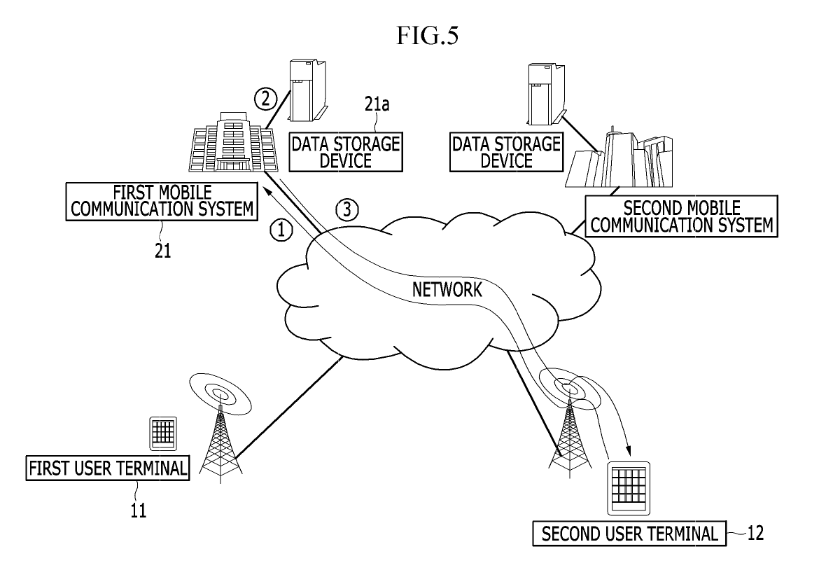

FIG. 4 shows a flowchart of a method for providing virtualization information according to the first exemplary embodiment of the present invention, and FIG. 5 shows an operation of each device in conjunction with storing virtualization information according to the first exemplary embodiment of the present invention.

As shown in FIG. 4 and FIG. 5, when the user that has stored virtualization information on the first user terminal 11 in the first mobile communication system 21 wants to use the virtualization information with another terminal 12 (will be referred to as “the second user terminal”) different from the first user terminal 11, the first mobile communication system 21 is requested to provide virtualization information by the second user terminal 12 S100.

Here, the second user terminal 12 may be the same type as that of the first user terminal or may be a different type. For example, the first user terminal 11 may be a smart terminal available for using a wireless data service such as a WiFi and the second user terminal 12 may be a digital device in which a network access device and an operating system are installed such as an Internet protocol television (IPTV) and voice over Internet protocol (VoIP) equipment, wherein the network run by the first mobile communication service provider user may be used.

The second user terminal 12 transmits the identification number of the first user terminal 11 to the first mobile communication system 21 to request virtualization information corresponding to the identification number. That is, an information requesting message including the identification number (here, the personal identification number of the first user terminal is used) corresponding to virtualization information to be received and the identification number of the second user terminal is transmitted to the first mobile communication system 21 S110. For better comprehension and ease of description, the identification number corresponding to the virtualization information will be referred as a first identification number and the identification number of the second user terminal will be referred as a second identification number.

The first mobile communication system 21 provides the virtualization information based on the received identification number. More specifically, based on the identification number of the second user terminal, that is, the second identification number included in the received information requesting message, the first mobile communication system 21 determines whether the second user terminal 12 is a subscriber capable of receiving a service. Then, the first mobile communication system 21 searches the requested virtualization information from the data storage device 21 a, based on the identification number of the first mobile communication system 21, that is, the first identification number. The first mobile communication system 21 transmits the searched virtualization information corresponding to the first identification number to the second user terminal 12 (S120, S130).

The second user terminal 12 receives the virtualization information from the first mobile communication system 21 (S140), and realizes a virtual device by using the shallow method or the deep method based on the virtualization information (S150).

For example, when a computing environment is established with the shallow method for sharing with the operating system, kernel, and others of the second user terminal 12, as shown in FIG. 1, a virtual device for sharing with the application and contents layer L5, operating system layer L4, library layer L3, and hardware and kernel layer L2 of the second user terminal is implemented in the second user terminal 12.

Meanwhile, when a computing environment is established with the deep method for realizing a virtual device for including independent layers, as shown in FIG. 2, a virtual device for including an application and contents layer L51, an operating system layer L41, a library layer L31, a hardware and kernel layer L21, and a network layer L11 that are independent from those of the second user terminal is implemented in the second user terminal 12.

According to the exemplary embodiment of the present invention, it is possible to use customized virtual information in a device to be currently used through a virtual machine (e.g. emulator) that is suitable for an operating system and a platform, regardless of the operating system of the device to be currently used. Therefore, the user can use the virtualization information with any type of device anytime and anywhere and be provided with the same service based on the virtualization information. Thus, a one-user multi-platform can be realized.

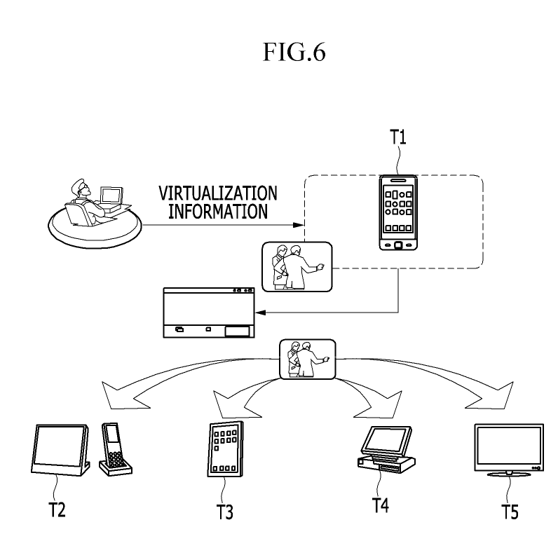

As above, the virtual device is implemented in the second user terminal 12, and a virtual machine corresponding to the application and contents layer of the virtual device runs the virtualization information (S160). For example, the virtual machine runs an application included in the virtualization information that corresponds to the first identification number, and processes the data that the user has separately stored or the phone book included in the virtualization information through a corresponding application to provide it to the user. Thus, the information customized for the user, as shown in FIG. 6, is provided.

FIG. 6 shows an example for providing customized information to a terminal by the method for providing virtualization information according to the first exemplary embodiment of the present invention.

As shown in FIG. 6, when a user processes the data used in a smart terminal T1 as virtualization information and stores it in a mobile communication system, the user may be provided with the virtualization information corresponding to the smart terminal T1 through a terminal T2 that is capable of using a service over IP (SoIP), an internet protocol TV (IPTV) T3, a personal computer (PC) T4, or a terminal T5 in the form of a pad.

The application and data used in the smart terminal may be executed by the virtual machine at a different type of terminal, and thereby they are processed to be suitable to the application or platform of the different type of terminal. As a result, the user may be provided with the same information and communication service that the user used to be provided in the smart terminal, through a terminal T2 that is capable of using a service over IP (SoIP), an internet protocol TV (IPTV) T3, a personal computer (PC) T4, or a terminal T5 in the form of a pad.

Particularly, according to the exemplary embodiment of the present invention, an identification number (e.g. a telephone number) for identifying a mobile communication service subscriber is provided along with the information customized for a user so that the user may use various services. For example, a mobile office service may be provided to an enterprise, and a service such as an N-screen may be provided to a user. Therefore, a user, regardless of the type of terminal and the type of operating system, can use the same virtualization information and communication service anytime and anywhere.

Meanwhile, the second user terminal 12 may be provided with the execution of virtualization information in a form of streaming through a virtual machine in a remote first mobile communication system to receive a service that is independent of the type of terminal.

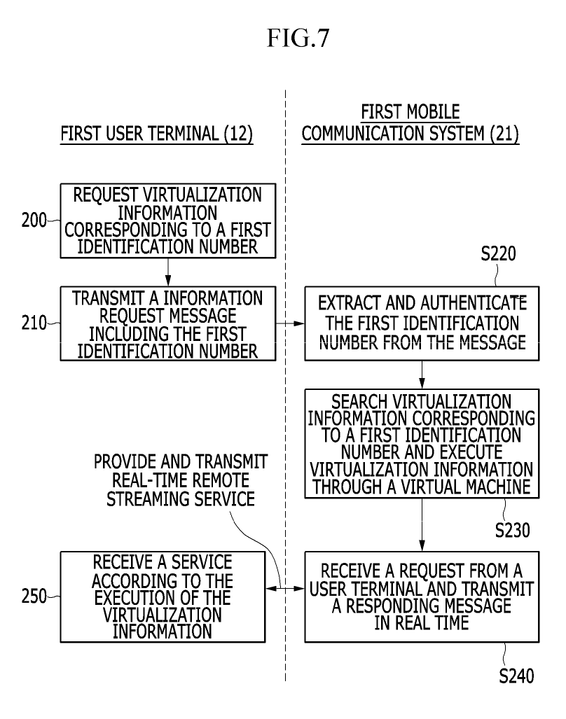

FIG. 7 shows a flowchart of another method for providing virtualization information according to the first exemplary embodiment of the present invention.

As in FIG. 4 and FIG. 5, the second user terminal 12 transmits an information requesting message including a first identification number of a first user terminal to the first mobile communication system 21 to request virtualization information (S200 and S210). The first mobile communication system 21 extracts the first identification number from the information requesting message and searches the virtualization information corresponding to the extracted first identification number (S220).

Here, the virtualization information corresponding to the first identification number is not executed at the second user terminal 12, but at the virtual machine of the first mobile communication system 21. The virtualization information is provided to the second user terminal 12 through the virtual machine. That is, after searching the virtualization information corresponding to the first identification number, the first mobile communication system 21 executes the virtualization information through the virtual machine (S230).

The first mobile communication system 21 processes the information and communication service generated by the execution of the virtualization information to be in the form of streaming and transmits them to the second user terminal 12 in real time (S240). The virtualization information of the first user terminal 11 is processed in a form of a remote streaming service in real time through the first mobile communication system 21 and is transmitted to the second user terminal 12, thereby a cloud service of the virtualization information is realized.

In the first exemplary embodiment, it is described that the virtualization information of the first user terminal is provided from the first mobile communication system 21 and is then executed at the second user terminal. However, it is possible for the first user terminal to receive its virtual information as above, if the first user terminal wants to receive it from the first mobile communication system 21, which may be embodied by a person of ordinary skill in the art based on the exemplary embodiment such that its detailed description will be omitted.

Meanwhile, in the first exemplary embodiment, the first mobile communication system 21 provides the virtualization information corresponding to the first identification number to the second user terminal 12 according to the request of the second user terminal. Then, the first mobile communication system 21 maps the first identification number with the second identification number to manage communication information that will be generated to the first identification number and the second identification number so that the first identification number is maintained in the second user terminal 12.

For this purpose, the first mobile communication system 21 includes a routing table. Here, the routing table is included in the data storage device 21 a, but is not limited thereto.

The first identification number is stored in the routing table to be mapped to the second identification number of the second user terminal, and the amount of the data that is transmitted/received based on the request of the second user terminal 12 is measured and stored in the routing table. That is, the usage of data that is requested for the first identification number and the usage of data that is requested for the second identification number, by the virtual device of the second user terminal 12, are respectively measured and will be used as data for billing. For example, the first identification number corresponding to the virtualization information that is provided for the second identification number of the second user terminal, and information indicating what type of, when, and how much data is provided are generated and used as billing data for the second identification number.

Next, the method for providing virtualization information according to the second exemplary embodiment of the present invention will be described.

The second exemplary embodiment of the present invention corresponds to the case in which virtualization information is provided through a different mobile communication system from a mobile communication system in which the virtualization information is stored.

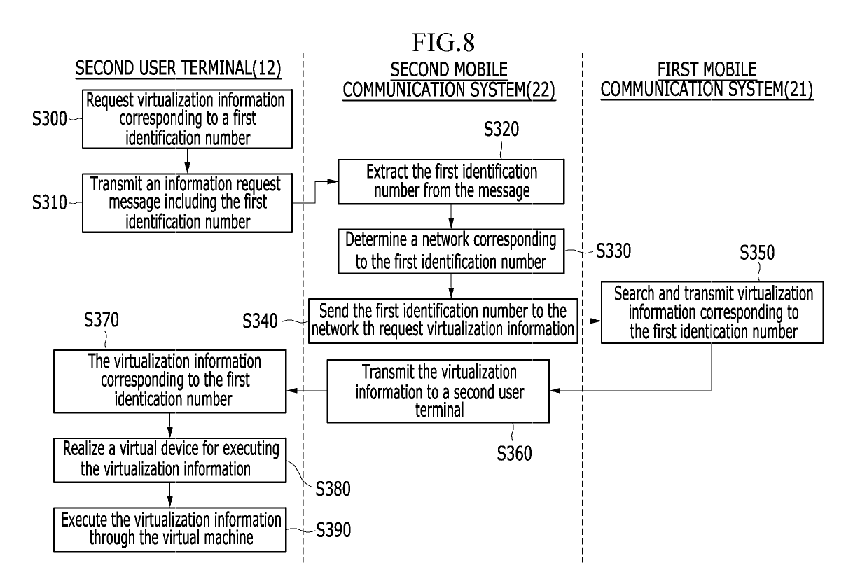

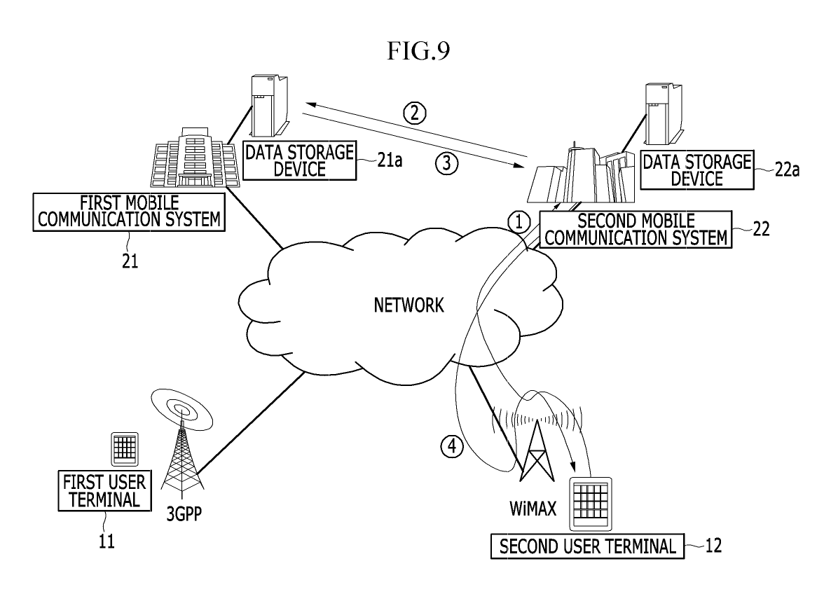

FIG. 8 shows a flowchart of a method for providing virtualization information according to the second exemplary embodiment of the present invention, and FIG. 9 shows an operation of each device in conjunction with storing virtualization information according to the second exemplary embodiment of the present invention.

Here, a first user terminal 11 is a terminal in which virtualization information is generated. A second user terminal 12 subscribes to a mobile communication system run by a network service provider that is different from a network service provider running a mobile communication system in which the first user terminal 11 stores the virtualization information.

As shown in FIG. 8 and FIG. 9, when the user that stores virtualization information for the first user terminal 11 in a first mobile communication system 21 wants to use the virtualization information with a second user terminal 12 that subscribes to a different communication service, the second user terminal 12 requests the virtualization information to a second mobile communication system 22 of the different communication service (S300).

The second user terminal 12 transmits the identification number of the first user terminal to the second mobile communication system 22 to request the virtualization information corresponding to the identification number. That is, the second user terminal 12 transmits an information requesting message including a first identification number corresponding to the virtualization information to be received and a second identification number of the second user terminal to the second mobile communication system 22 (S310).

The second mobile communication system 22 identifies a network system in which the virtualization information corresponding to the first identification number extracted from the information requesting message is stored, that is, the first mobile communication system 21 (S320 and S330). In this case, the second mobile communication system 22 determines whether the second user terminal 12 is a subscriber capable of using a service based on the second identification number. When the second user terminal 12 is the subscriber, the next operation may be performed.

The second mobile communication system 22 transmits the first identification number to the first mobile communication system 21 to request the corresponding virtualization information (S340). The first mobile communication system 21 searches the virtualization information requested by the user from the data storage device 21a based on the first identification number and sends it to the second mobile communication system 22 (S350). Here, the first mobile communication system 21 may performs the authentication for the user so that the virtualization information may be used by a legitimate user.

The second mobile communication system 22 transmits the virtualization information send from the first mobile communication system 21 to the second user terminal 12 (S360). The second user terminal 12 implements a virtual device based on the virtualization information with the deep method or the shallow method as in the first exemplary embodiment, and executes the virtualization information on the virtual device (S370-S390). Accordingly, the customized information as in FIG. 6 may be provided to the second user terminal 12.

Also, in the second exemplary embodiment, the second user terminal 12 may be provided with the execution of virtualization information in a form of streaming through a virtual machine in the remote second mobile communication system to receive a service that is independent of the type of terminal.

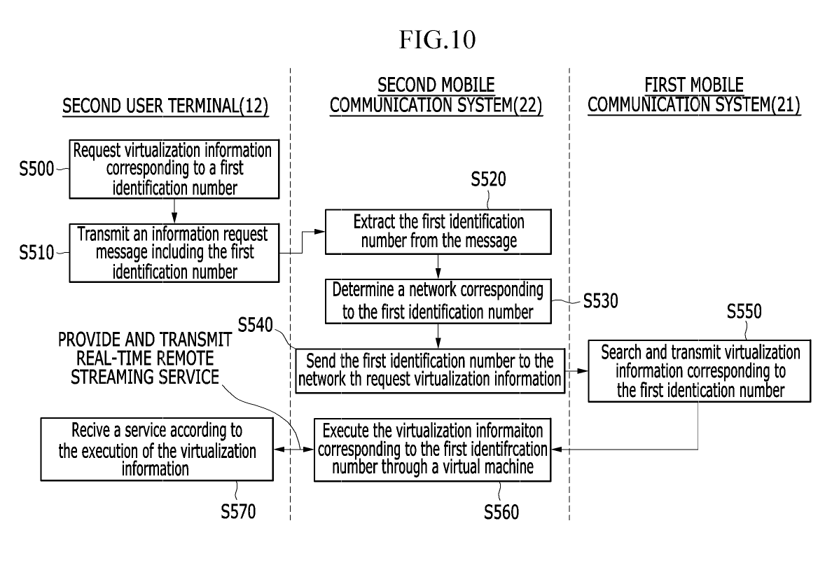

FIG. 10 shows a flowchart of another method for providing virtualization information according to the second exemplary embodiment of the present invention.

In the same way as with the method in FIG. 8 and FIG. 9, the second user terminal 12 transmits an information requesting message including the first identification number of a first user terminal to a second mobile communication system 22 to request virtualization information (S500 and S510). Then, the second mobile communication system 22 requests the virtualization information for a first mobile communication system 21 of a network service corresponding to the first identification number (S520-S550).

Unlike in FIG. 8 and FIG. 9, the second mobile communication system 22 executes the virtualization information through a virtual machine and then transmits the executed virtual information in a form of a streaming service to the second user terminal 12. That is, after receiving the virtualization information corresponding to the first identification number from the first mobile communication system 21, the second mobile communication system 22 executes the virtualization information through the virtual machine (S560).

The second mobile communication system 22 processes the information and communication service generated by the execution of the virtualization information in a form of streaming and transmits them to the second user terminal 12 in real time (S570).

According to the second exemplary embodiment of the present invention, the second user terminal 12 uses the first identification number alone with the second identification number, and a service based on the first identification number is provided to the second user terminal 12 through the second mobile communication system 22.

The service based on the first identification number is provided through a network of the second mobile communication system 22, and thereby the first mobile communication system 21 performs the billing for the service for the first user terminal emulated in the second user terminal along with the second mobile communication system 22.

For this purpose, after providing the virtualization information corresponding to the first identification number based on the request from the second mobile communication system 21, the first mobile communication system 21 stores the first identification number and the second identification number to be mapped to each other in the routing table of the data storage device 21 a and manages information on data that is transmitting/received for the first identification number and the second identification number.

For example, the first mobile communication system 21 stores the network identification number of the second mobile communication system 22 and the second identification number of the second user terminal to be mapped to the first identification number, and measures and stores the amount of data that is provided to the second mobile communication system 22 based on the first identification number.

Also, the second mobile communication system 22 stores the first identification number and the second identification number to be mapped to each other in a routing table of its data storage device 22a after providing the virtualization information corresponding to the first identification number according to the request of the second user terminal 12. Then the second mobile communication system 22 manages the information on the data that is transmitted/received based on the first identification number and the second identification number. For example, the second mobile communication system 22 measures the amount of data that is provided to the second user terminal based on the first identification number and stores it to be mapped to the second identification number.

As above, the first mobile communication system 21 and the second mobile communication system 22 respectively store and manage the information on the data that is provided based on the first identification number and the second identification number, and the information will be used as billing data.

The second identification number and the first identification number of the first user terminal are maintained and managed at the second user terminal 12. Therefore, a service based on each of the second identification number and the first identification number is provided. Also, the service may be provided through the second mobile communication system 22 and the first mobile communication system 21. Substantially, a service (e.g. a service for providing information, communication, and broadcasting) based on the first identification number may be provided by leasing the network of the second mobile communication system 22.

Meanwhile, the first mobile communication system 21 disconnects from the first user terminal when a service based on the first identification number is requested by the second user terminal through the second mobile communication system 22. For example, when receiving a request for a call connection for the first identification number, the first mobile communication system 21 requests a roaming service to the second mobile communication system 22. The second mobile communication system 22 connects the call with the second user terminal 12.

According to the second exemplary embodiment of the present invention, services based on the same identification number may be provided through various communication service networks, and the same virtualization information may be used through different communication services. As a result, one-user and multi-mobile network operator may be possible.

According to the exemplary embodiments of the present invention, a user may use the same virtualization information through various communication services anytime and anywhere, regardless of the type of terminal used by the user. Also, the information stored in a universal subscriber identifying module (USIM) is processed as virtualization information and then may be used at various terminals through various communication services. Further, without the hassle of attaching or detaching the USIM or the risk of losing the USIM, the information of the USIM may be used in various terminals. In addition, for a one-person multi-device (OPMD), one-user one-USIM, that is, one user may use one USIM.

Also, as well as a service for storing data through a general cloud service, an identification number (e.g., a phone number) of a user that subscribes to a mobile communication service and information customized for the user are processed and used as virtualization information. As a result, the user may be provided with the same service based on the identification number anytime and anywhere, regardless of the type of terminal to be used, and may use the same data included in the virtualization information.

Also, for terminals with various operating systems providing different platforms, customized information is executed and used through an emulator that is suitable to each operating system and platform, and a service based on the same identification number may be provided.

In addition, virtualization information optimized for a mobile communication environment is used, and thereby it is possible to access the virtualization information regardless of the type of terminal. Also, a mobile communication service may be provided in a using terminal through an identification number like a telephone number.

An exemplary embodiment of the present invention may not only be embodied through the above-described apparatus and/or method, but may also be embodied through a program that executes a function corresponding to a configuration of an exemplary embodiment of the present invention and through a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for providing virtualization information,
wherein virtualization information for a first user terminal is stored in a data storage device through a mobile communication system, and the virtualization information includes a first identification number for identifying the first user terminal and information generated by using the first user terminal, comprising:
transmitting, by the second user terminal, a message including the first identification number of the first user terminal to the mobile communication system to request virtualization information; and
receiving, by the second user terminal, the virtualization information corresponding to the first identification number from the mobile communication system.

2. The method of claim 1, wherein the receiving of the virtualization information includes:
receiving, by the second user terminal, the virtualization information corresponding to the first identification number from the mobile communication system;
installing, by the second user terminal, a virtual device for the virtualization information; and
executing, by the virtual device, the virtualization information.

3. The method of claim 1, wherein the receiving of the virtualization information includes
receiving, by the second user terminal, an information and communication service according to execution of virtualization information corresponding to the first identification number from the mobile communication system,
wherein the mobile communication system executes the virtualization information corresponding to the first identification number through a virtual machine, and provides the information and communication service according to the execution of the virtualization information to the second user terminal.

4. The method of claim 1, further comprising
mapping, by the mobile communication system, the first identification number to the second identification number to manage information on data that is transmitted/received based on the first identification number and the second identification number after providing the virtualization information corresponding to the first identification number to the second user terminal.

5. The method of claim 1, further comprising
providing, by the mobile communication system, a requested service to the second user terminal when receiving a request for a service corresponding to the first identification number.

6. The method of claim 1, further comprising:
performing, by the mobile communication system, authentication based on the first identification number included in the message received from the second user terminal; and
providing, by the mobile communication system, the virtualization information corresponding to the first identification number to the second user terminal when the authentication has succeeded.

7. A method for providing virtualization information,
wherein virtualization information for a first user terminal is stored in a data storage device through a first mobile communication system, and the virtualization information includes a first identification number for identifying the first user terminal and information generated by using the first user terminal, comprising:
transmitting, by the second user terminal, a message including the first identification number of the first user terminal to a second mobile communication system to request virtualization information; and
receiving, by the second user terminal, the virtualization information corresponding to the first identification number from the second mobile communication system after the virtualization information is sent from the first mobile communication system to the second mobile communication system.

8. The method of claim 7, wherein the receiving includes:
receiving, by the second user terminal, the virtualization information corresponding to the first identification number from the second mobile communication system;
installing, by the second user terminal, a virtual device for the virtualization information; and
executing, by the virtual device, the virtualization information.

9. The method of claim 7, wherein the receiving may include
receiving, by the second user terminal, an information and communication service according to execution of virtualization information corresponding to the first identification number from the second mobile communication system.
wherein the second mobile communication system executes the virtualization information corresponding to the first identification number through a virtual machine, and provides the information and communication service according to the execution of the virtualization information to the second user terminal.

10. The method of claim 7, further comprising:
providing, by the first mobile communication system, a service corresponding to the first identification number to the second mobile communication system when the service is requested from the second mobile communication system; and
providing, by the second mobile communication system, the service corresponding to the first identification number to the second user terminal.

11. The method of claim 7, further comprising:
mapping, by the first mobile communication system, a network identification number of the second mobile communication system and a second identification number of the second user terminal to the first identification number to manage information on data that is transmitted/received based on the first identification number; and
mapping, by the second mobile communication system, the second identification number of the second user terminal to the first identification number to manage information on data that is transmitted/received based on the first identification number and the second identification number.

12. The method of claim 2, wherein the virtual device includes a network layer, and further includes a hardware and kernel layer, a library layer, an operating system layer, and an application and contents layer including a virtual machine, which are shared by the second user terminal.

13. The method of claim 8, wherein the virtual device includes a network layer, and further includes a hardware and kernel layer, a library layer, an operating system layer, and an application and contents layer including a virtual machine, which are shared by the second user terminal.

14. The method of claim 2, wherein the virtual device includes a network layer, a hardware and kernel layer, a library layer, an operating system layer, and an application and contents layer including a virtual machine, which are independent of the second user terminal.

15. The method of claim 8, wherein the virtual device includes a network layer, a hardware and kernel layer, a library layer, an operating system layer, and an application and contents layer including a virtual machine, which are independent of the second user terminal.

16. The method of claim 1, wherein the virtualization information includes information on an application used in the first user terminal, information stored in a universal subscriber identity module (USIM) card, data stored in the first user terminal, information on a user interface (UI) of the first user terminal, and financial transaction information.

17. The method of claim 7, wherein the virtualization information includes information on an application used in the first user terminal, information stored in a universal subscriber identity module (USIM) card, data stored in the first user terminal, information on a user interface (UI) of the first user terminal, and financial transaction information.

18. The method of claim 1, wherein the first identification number is a phone number of the first user terminal.

19. The method of claim 1, wherein a type of the first user terminal is different from a type of the second user terminal.

20. The method of claim 7, wherein a type of the first user terminal is different from a type of the second user terminal.
